(19) United States
(12) Patent Application Publication
(10) Pub. No.: US 2024/0044512 A1
(43) Pub. Date: Feb. 8, 2024

(54) OVEN LID OF LARGE-CAPACITY AIR OVEN

(71) Applicant: Ningbo Borine Electric Applicance Co. Ltd., Ningbo City Zhejiang Province (CN)

(72) Inventors: Fangsheng DAI, Ningbo City Zhejiang Province (CN); Yiwei XU, Ningbo City Zhejiang Province (CN); Junchao YUAN, Ningbo City Zhejiang Province (CN); Jian WANG, Ningbo City Zhejiang Province (CN)

(21) Appl. No.: 18/216,821

(22) Filed: Jun. 30, 2023

(30) Foreign Application Priority Data
Aug. 4, 2022 (CN) 202222042359.8

(51) Int. Cl. F24C 15/32

(52) U.S. Cl. CPC F24C 15/325

(57) ABSTRACT

The present invention discloses an oven lid of a large-capacity air oven. The key point of the technical solution of the present invention is that the oven lid of the large-capacity air oven includes a casing, a middle casing is arranged inside the casing, and an inner casing is fixedly connected to the bottom of the middle casing; a DC brushless motor is employed, and due to the fact that the size of the DC brushless motor is small, which allows the space between the inner casing and the middle casing to be compressed, thereby expanding the volume of an inner oven body and making the space of the air oven larger; and in addition, a first recess, a second recess and a third recess are provided, so that structures among the middle casing, the inner casing, an exhaust fan and a circulation fan are more compact.

### CROSS-REFERENCE TO RELATED APPLICATIONS

The present application claims priority to Application No. 202222042359.8, filed in the Chinese Patent Office on Aug. 4, 2022, which is expressly incorporated herein in its entirety by reference thereto.

### TECHNICAL FIELD

The present invention relates to the field of air ovens, and in particular, to an oven lid of a large-capacity air oven.

### BACKGROUND ART

At the present stage, in the family kitchen, there is often an air oven, and the air oven uses hot air circulation in the oven to cook food; a fan assembly is arranged on an oven lid of the air oven, and includes a motor, an exhaust fan and a circulation fan which are connected to the motor, and the like; and the motor drives the exhaust fan and the circulation fan to rotate so as to realize functions such as hot air circulation.

In the prior art, a shade-pole motor is often employed as the motor; and due to the larger size of the shaded-pole motor, it occupies a large space, resulting in a larger appearance and less compact structure of the oven lid.

### SUMMARY OF THE INVENTION

In view of the shortcomings of the prior art, the purpose of the present invention is to provide an oven lid of a large-capacity air oven, which is used for reducing the space occupied by the motor on the oven lid.

In order to achieve the above purpose, the present invention provides the following technical solution: an oven lid of a large-capacity air oven includes a casing, where a middle casing is arranged inside the casing, an inner casing is fixedly connected to the bottom of the middle casing, a heat dissipation cavity is formed between the middle casing and the inner casing, and a central hole communicated with the heat dissipation cavity is provided on the middle casing; a DC brushless motor is fixedly connected to the middle casing, and an interstice is provided between the DC brushless motor and the central hole; an output shaft of the DC brushless motor is fixedly connected to an exhaust fan and a circulation fan, the circulation fan is located under the inner casing, and the exhaust fan is located inside the heat dissipation cavity; and an exhaust component is communicated with one side of the middle casing, and an air outlet is provided on the exhaust component.

As a further improvement of the present invention, a plurality of supports are arranged along the outer side surface of the DC brushless motor in an integrated molding manner, and the supports are fixedly connected to the middle casing.

As a further improvement of the present invention, there are three supports, the three supports are evenly distributed along the circumferential direction of the output shaft of the DC brushless motor.

As a further improvement of the present invention, a plurality of positioning slots corresponding to the supports are provided on the upper surface of the middle casing.

As a further improvement of the present invention, a first recess is formed on the exhaust fan, and at least portion of the DC brushless motor enters the first recess.

As a further improvement of the present invention, a second recess is formed on the inner casing, and at least portion of the first recess enters the second recess.

As a further improvement of the present invention, a third recess is formed on the circulation fan, and at least portion of the second recess enters the third recess.

As a further improvement of the present invention, a through hole is provided on the inner casing, an exhaust hole is provided on the middle casing, and the exhaust hole corresponds to the through hole and is communicated with the exhaust component.

As a further improvement of the present invention, the first recess includes a first recess bottom surface and a first circular truncated cone side surface, and the slope of the first circular truncated cone side surface is A1, with A1 being 30 degrees;

the second recess includes a second recess bottom surface and a second circular truncated cone side surface, and the slope of the second circular truncated cone side surface is A2, with A2 being 30 degrees; and

the third recess includes a third recess bottom surface and a third circular truncated cone side surface, and the slope of the third circular truncated cone side surface is A3, with A3 being 30 degrees.

As a further improvement of the present invention, the exhaust fan includes the first recess and a plurality of first fan blades arranged outside the first recess in a surrounding manner; the circulation fan includes the third recess and a plurality of second fan blades arranged outside the third recess in a surrounding manner;

each of the first fan blades includes a first fan plate and a first positioning plate which are connected to each other, the cross section of the fan blade formed by connecting the first fan plate and the first positioning plate is L-shaped, the included angle between the first fan plate and the first positioning plate is D1, with D1 being 90 degrees, and the first fan plate extends in the direction opposite to the forming direction of the first recess; and

each of the second fan blades includes a second fan plate and a second positioning plate which are connected to each other, the cross section of the fan blade formed by connecting the second fan plate and the second positioning plate is L-shaped, the included angle between the second fan plate and the second positioning plate is D3, with D3 being 90 degrees, and the second fan plate extends towards the recess direction in which the third recess is formed.

As a further improvement of the present invention, each of the first fan blades includes a first positioning plate reinforcement portion, and the first positioning plate reinforcement portion is arranged on the surface of the first positioning plate and protrudes in a direction opposite to the forming direction of the first recess.

As a further improvement of the present invention, each of the first positioning plates is approximately a right-angled triangle, and includes a first base portion, a first straight edge, a first top boundary and a first hypotenuse which are connected in sequence, where the first positioning plate is connected to the first recess by means of the first base portion, the first straight edge extends radially through a center of the circle of the first recess, the first hypotenuse is connected to the first fan plate, the height of the inner casing away from the bottom edge of the first fan plate is B1, with B1 being 4 mm, and the height from the bottom edge of the first fan plate to the top edge thereof is B2, with B2 being 9.4 mm; and

as a further improvement of the present invention, the exhaust fan includes the ten first fan blades evenly surrounding the edge of the first recess, and the included angle formed between the first straight edge of each first positioning plate and the first hypotenuse of the adjacent first positioning plate is D2, with D2 being 51 degrees.

As a further improvement of the present invention, the first positioning plates are evenly distributed around the first recess, and an interstice is formed between the every two adjacent first positioning plates; first fan blade chamfered mouths are formed by the interstices, and each of the first fan blade chamfered mouths includes a first fan blade main transition arc and a first fan blade auxiliary transition arc, where the first fan blade main transition arc is used for connecting the first hypotenuse and the first base portion, the first fan blade auxiliary transition arc is used for connecting the first straight edge and the first base portion, and the bending directions of the first fan blade main transition arc and the first fan blade auxiliary transition arc are opposite to each other.

As a further improvement of the present invention, each of the second fan blades includes a second positioning plate reinforcement portion, and the second positioning plate reinforcement portion is arranged on the surface of the second positioning plate and protrudes towards the recess direction in which the third recess is formed.

As a further improvement of the present invention, each of the second positioning plates is approximately a right-angled triangle, and includes a second base portion, a second straight edge, a second top boundary and a second hypotenuse which are connected in sequence, where the second positioning plate is connected to the third recess by means of the second base portion, the second straight edge extends radially through a center of the circle of the third recess, the second hypotenuse is connected to the second fan plate, the height of the inner casing away from the bottom edge of the second fan plate is B3, with B3 being 3.6 mm, and the height from the bottom edge of the second fan plate to the top edge thereof is B4, with B4 being 13.5 mm; and

as a further improvement of the present invention, the circulation fan includes the ten second fan blades evenly surrounding the edge of the third recess, and the included angle formed between the second straight edge of each second positioning plate and the second hypotenuse of the adjacent second positioning plate is D4, with D4 being 53 degrees.

As a further improvement of the present invention, the second positioning plates are evenly distributed around the third recess, and an interstice is formed between the every two adjacent second positioning plates; second fan blade chamfered mouths are formed by the interstices, and each of the second fan blade chamfered mouths includes a second fan blade main transition arc and a second fan blade auxiliary transition arc, where the second fan blade main transition arc is used for connecting the second hypotenuse and the second base portion, the second fan blade auxiliary transition arc is used for connecting the second straight edge and the second base portion, and the bending directions of the second fan blade main transition arc and the second fan blade auxiliary transition arc are opposite to each other.

As a further improvement of the present invention, the exhaust component extends towards the outer side of the middle casing, the air outlet is provided on the exhaust component, and the shape of the air outlet is grid-shaped; the middle casing includes a middle casing bottom plate extending along a plane, and a middle casing side wall extending from the middle casing bottom plate towards one side; the middle casing side wall is provided with the exhaust hole; the exhaust component includes an exhaust component top surface and an exhaust component bottom surface which are arranged in sequence along the direction from the middle casing bottom plate to the middle casing side wall; the exhaust component bottom surface includes a planar bottom wall and an arc-shaped bottom wall that are connected in sequence; and the air outlet is provided at the side of the exhaust component top surface close to the arc-shaped bottom wall.

As a further improvement of the present invention, the middle casing is formed by two-stage upward draft, so that a step-like middle casing stair-shaped surface is formed at the waist of the middle casing; the draft slope of the first stage of the middle casing is C1, with C1 being 15 degrees; the draft slope of the second stage of the middle casing is C2, with C2 being 15 degrees; and the inner casing has a circular inclined plane, the slope of the inclined plane is C3, with C3 being 30 degrees.

As a further improvement of the present invention, the exhaust component is provided with a plurality of reinforcing ribs.

As a further improvement of the present invention, the first recess includes a first crisscross recess, and the first crisscross recess is formed by means of draft towards the recess direction of the first recess; and the third recess includes a second crisscross recess, and the second crisscross recess is formed by means of draft in the direction opposite to the recess direction of the third recess.

As a further improvement of the present invention, the first recess is formed on the exhaust fan, and at least portion of the DC brushless motor enters the first recess; and

the second recess is formed on the inner casing, and at least portion of the first recess enters the second recess.

The third recess is formed on the circulation fan, and at least portion of the second recess enters the third recess; and

the plurality of supports are arranged along the outer side surface of the DC brushless motor in an integrated molding manner, and the supports are fixedly connected to the inner casing.

As a further improvement of the present invention, the first recess is matched with the outer wall of the DC brushless motor.

In order to achieve the above purpose, the present invention provides another technical solution: an oven lid of a large-capacity air oven includes an inner casing, where a DC brushless motor is fixedly connected to the inner casing, an output shaft of the DC brushless motor is connected to an exhaust fan and a circulation fan, the exhaust fan is located above the inner casing, and the circulation fan is located under the inner casing; a first recess is formed on the exhaust fan, and at least portion of the DC brushless motor enters the first recess;

a second recess is formed on the inner casing, and at least portion of the first recess enters the second recess; and

a third recess is formed on the circulation fan, and at least portion of the second recess enters the third recess.

The present invention has the beneficial effects that: the DC brushless motor is employed, and due to the fact that the size of the DC brushless motor is small, the space occupied by the DC brushless motor is small, which allows the space between the inner casing and the middle casing to be compressed, thereby expanding the volume of an inner oven body and making the space of the air oven larger; and in addition, the first recess, the second recess and the third recess are provided, so that structures among the middle casing, the inner casing, the exhaust fan and the circulation fan are more compact, and interstices between the inner casing and the middle casing and between the circulation fan and the inner casing are further reduced.

### BRIEF DESCRIPTION OF THE DRAWINGS

FIG. 1 is a schematic diagram of a three-dimensional structure of the present invention;

FIG. 2 is a cross-sectional view of the present invention;

FIG. 3 is a schematic diagram of the structure of a middle casing according to the present invention;

FIG. 4 is a schematic diagram of the structure of an exhaust fan according to the present invention;

FIG. 5 is a schematic diagram of the structure of an inner casing according to the present invention;

FIG. 6 is a schematic diagram of the structure of a circulation fan according to the present invention;

FIG. 7 is a partial cross-sectional view of the present invention;

FIG. 8 is a partially enlarged cross-sectional view of the present invention;

FIG. 9 is a schematic diagram of the structure of the exhaust fan and a partially enlarged view of the fan blade portion of the exhaust fan according to the present invention;

FIG. 10 is a schematic diagram of the structure of the circulation fan and a partially enlarged view of the fan blade portion of the circulation fan according to the present invention;

FIG. 11 is an exploded view of the exhaust fan, the middle casing, and the circulation fan according to the present invention;

FIG. 12 is a partial enlarged view of the exhaust fan and the circulation fan according to the present invention;

FIG. 13 is a schematic diagram of the three-dimensional structure of the present invention from another angle;

FIG. 14 is a partial cross-sectional view of another embodiment according to the present invention;

FIG. 15 is a combined schematic diagram of a brushless motor and an exhaust fan in Embodiment III according to the present invention;

FIG. 16 is an exploded schematic diagram of a brushless motor and an exhaust fan in Embodiment IV according to the present invention; and

FIG. 17 is a schematic diagram of a partial three-dimensional structure in Embodiment IV according to the present invention.

The reference numerals on the drawings are described below: 1 denotes a middle casing; 11 denotes a central hole; 12 denotes positioning slots; 13 denotes an exhaust hole; 14 denotes a middle casing bottom plate; 15 denotes a middle casing side wall; 16 denotes a middle casing stair-shaped surface; 2 denotes an inner casing; 21 denotes a second recess; 211 denotes a second recess bottom surface; 212 denotes a second circular truncated cone side surface; 22 denotes a through hole; 3 denotes a heat dissipation cavity; 4 denotes a DC brushless motor; 41 denotes an exhaust fan; 411 denotes a first recess; 4111 denotes a first recess bottom surface; 4112 denotes a first circular truncated cone side surface; 4113 denotes a first crisscross recess; 412 denotes first fan blades; 4121 denotes first fan plates; 41221 denotes first base portions; 41222 denotes first straight edges; 41223 denotes first top boundaries; 41224 denotes first hypotenuses; 4122 denotes first positioning plates; 4123 denotes first positioning plate reinforcement portions; 4124 denotes first fan blade chamfered mouths; 41241 denotes first fan blade main transition arcs; 41242 denotes first fan blade auxiliary transition arcs; 42 denotes a circulation fan; 421 denotes a third recess; 4211 denotes a third recess bottom surface; 4212 denotes a third circular truncated cone side surface; 4213 denotes a second crisscross recess; 422 denotes second fan blades; 4221 denotes second fan plates; 4222 denotes second positioning plates; 4223 denotes second positioning plate reinforcement portions; 4224 denotes second fan blade chamfered mouths; 42241 denotes second fan blade main transition arcs; 42242 denotes second fan blade auxiliary transition arcs; 43 denotes supports; 5 denotes an exhaust component; 51 denotes an air outlet; 52 denotes an exhaust component top surface; 53 denotes an exhaust component bottom surface; 531 denotes a planar bottom wall; and 532 denotes an arc-shaped bottom wall.

### DETAILED DESCRIPTION OF THE INVENTION

The present invention will be further described in detail below in conjunction with the accompanying drawings and embodiments. The same components are denoted by the same reference numerals on the drawings. It should be noted that the terms “front”, “rear”, “left”, “right”, “upper” and “lower” used in the following description refer to directions in the drawings, and the terms “bottom surface” and “top surface” as well as “inner” and “outer” refer to directions toward and away from the geometric center of a particular component, respectively.

### Embodiment I

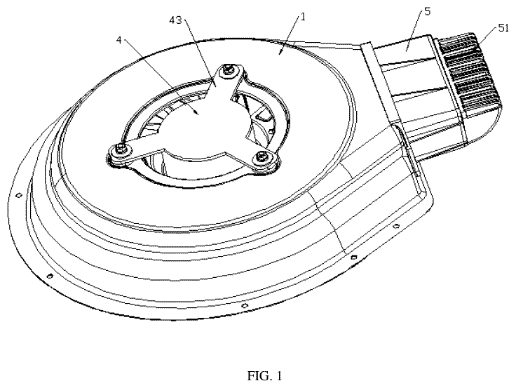

Referring to FIG. 1 to FIG. 6, an oven lid of a large-capacity air oven provided by the embodiment includes a casing (not shown in the figure) and a fan assembly; the air oven includes an outer oven body and an inner oven body, and a cavity is formed between the outer oven body and the inner oven body; a middle casing 1 is arranged inside the casing, and an inner casing 2 is fixedly connected to the bottom of the middle casing 1; a heat dissipation cavity 3 is formed between the middle casing 1 and the inner casing 2, and a central hole 11 communicated with the heat dissipation cavity 3 is provided on the middle casing 1; and a DC brushless motor 4 is fixedly connected to the middle casing 1. Due to the facts that the DC brushless motor 4 is small in size and the axial dimension of the DC brushless motor is shorter than that of a shade-pole motor, the space occupied by the DC brushless motor is small, which allows the space between the inner casing 2 and the middle casing 1 to be compressed, thereby expanding the volume of the inner oven body, making the space of the air oven larger, enabling the structure between the middle casing 1 and the inner casing 2 to be more compact, and reducing the overall mass of the oven lid. An interstice is provided between the DC brushless motor 4 and the central hole 11, the hot air in the cavity is drawn in by an exhaust fan 41 through the interstice and sent out by an exhaust component 5, so as to maintain the temperature inside the outer oven body and prevent same from being overheated. An output shaft of the DC brushless motor 4 is fixedly connected to the exhaust fan 41 and a circulation fan 42, the circulation fan 42 is located below the inner casing 2 and used for blowing the air towards food, and the hot air circulates inside the inner oven body. The exhaust fan 41 is located in the heat dissipation cavity 3, one side of the middle casing 1 is communicated with the exhaust component 5, and an air outlet 51 is provided on the exhaust component.

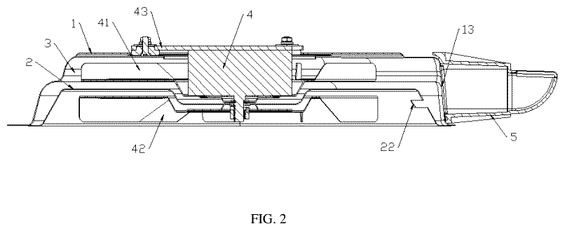

Referring to FIG. 1 and FIG. 2, a plurality of supports 43 are arranged along the outer side surface of the DC brushless motor 4 in an integrated molding manner, and the supports 43 are fixedly connected to the middle casing 1; the supports 43 are provided with fixing holes, and are fixedly connected to the middle casing 1 by means of standard components such as bolts and nuts; and a gasket is placed between each of the supports 43 and the middle casing 1 so as to prevent the support 43 from crushing the middle casing 1 during fixation.

There are three supports 43, the three supports are evenly distributed along the circumferential direction of the output shaft of the DC brushless motor 4, with a spacing angle of 120 degrees between the every two adjacent supports 43. Due to the arrangement of the three supports 43, the DC brushless motor 4 is enabled to be more stable.

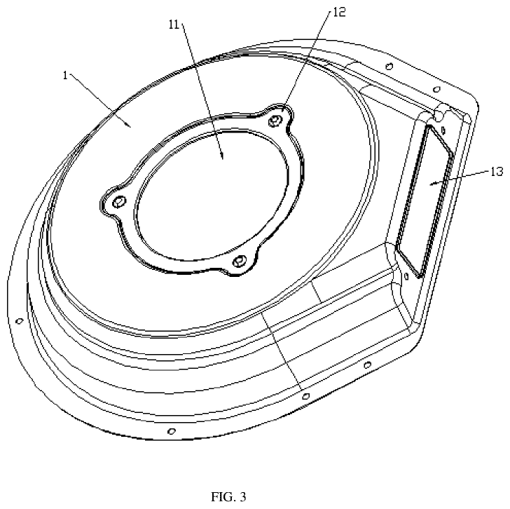

Referring to FIG. 3, a plurality of positioning slots 12 corresponding to the supports 43 are provided on the upper surface of the middle casing 1. The positioning slots 12 are used for positioning the supports 43; and after the installation position of the DC brushless motor 4 is determined, the installation is facilitated. The positioning slots 12 are provided with connecting holes corresponding to the fixing holes, and the bolts pass through the fixing holes and the connecting holes to fix the supports 43 and the middle casing 1.

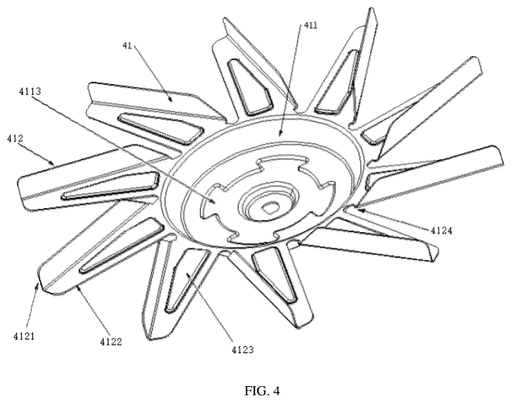

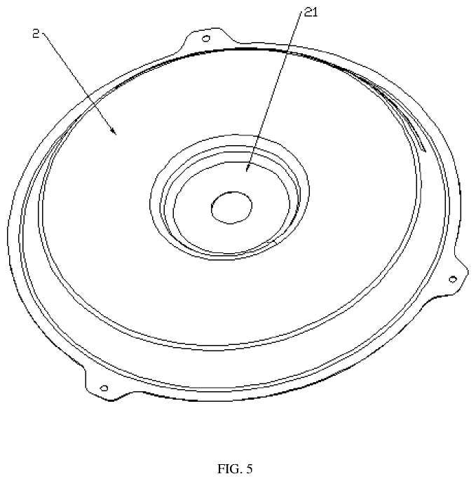

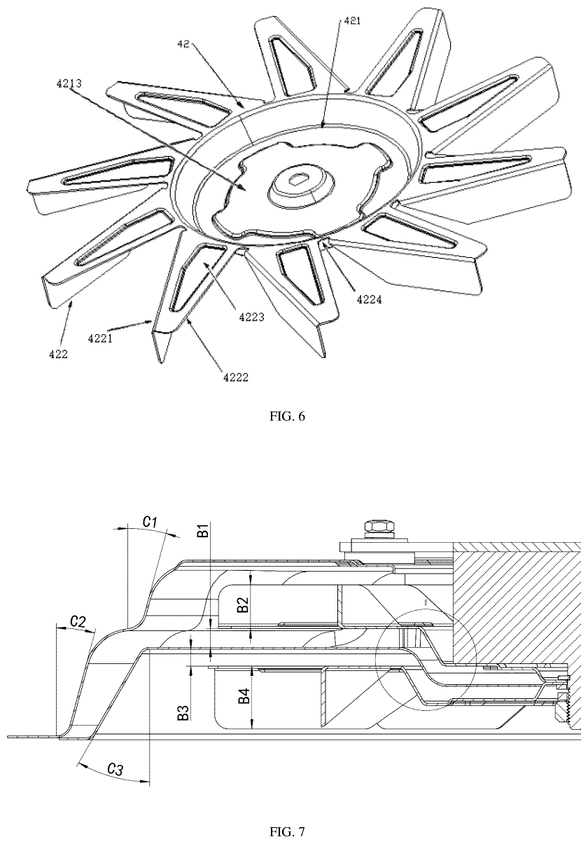

Referring to FIG. 2, FIG. 4, FIG. 5 and FIG. 6, a first recess 411 is formed on the exhaust fan 41, and at least portion of the DC brushless motor 4 enters the first recess 411. The exhaust fan 41 includes a plurality of first fan blades and a first connecting body located at the central portion of the exhaust fan, where the first connecting body and the first fan blades are integrally formed, and the first recess 411 is formed on the first connecting body, which gives a space for partially accommodating the DC brushless motor 4, so that the space occupied by the heat dissipation cavity 3 at the fan blade portion can be compressed, and the structure is more compact.

A second recess 21 is formed on the inner casing 2, and at least portion of the first recess 411 enters the second recess 21. The second recess 21 provides an accommodating space for the first recess 411, and reduces the interstice between the inner casing 2 and the exhaust fan 41, so that the structure between the inner casing 2 and the exhaust fan 41 is enabled to be more compact.

A third recess 421 is formed on the circulation fan 42, and at least portion of the second recess 21 enters the third recess 421. The circulation fan 42 includes a plurality of second fan blades and a second connecting body located at the central portion of the circulation fan, where the second connecting body and the second fan blades are integrally formed, and the third recess 421 is formed on the second connecting body, which gives an accommodating space for the second recess 21, and allows the structure between the second fan blades and the inner casing 2 to be more compact, so that the space of the air oven is expanded.

A through hole 22 is provided on the inner casing 2, an exhaust hole 13 is provided on the middle casing 1, the exhaust hole 13 corresponds to the through hole 22 and is communicated with the exhaust component 5, and the circulation air of a second fan may come from the through hole 22.

As shown in FIG. 7, the first recess 411 includes a first recess bottom surface 4111 and a first circular truncated cone side surface 4112, and the slope of the first circular truncated cone side surface 4112 is A1, with A1 being 30 degrees;

the second recess 21 includes a second recess bottom surface 211 and a second circular truncated cone side surface 212, and the slope of the second circular truncated cone side surface 212 is A2, with A2 being 30 degrees; and

the third recess 421 includes a third recess bottom surface 4211 and a third circular truncated cone side surface 4212, and the slope of the third circular truncated cone side surface 4212 is A3, with A3 being 30 degrees.

As shown in FIG. 4 and FIG. 5, the exhaust fan 41 includes the first recess 411 and a plurality of first fan blades 412 arranged outside the first recess 411 in a surrounding manner; and the circulation fan 42 includes the third recess 421 and a plurality of second fan blades 422 arranged outside the third recess 421 in a surrounding manner.

Further, each of the first fan blades 412 includes a first fan plate 4121 and a first positioning plate 4122 which are connected to each other, the cross section of the fan blade formed by connecting the first fan plate and the first positioning plate is L-shaped, the included angle between the first fan plate 4121 and the first positioning plate 4122 is D1, with D1 being 90 degrees, and the first fan plate 4121 extends in the direction opposite to the forming direction of the first recess 411; and

each of the second fan blades 422 includes a second fan plate 4221 and a second positioning plate 4222 which are connected to each other, the cross section of the fan blade formed by connecting the second fan plate and the second positioning plate is L-shaped, the included angle between the second fan plate 4221 and the second positioning plate 4222 is D3, with D3 being 90 degrees, and the second fan plate 4221 extends towards the recess direction in which the third recess 421 is formed.

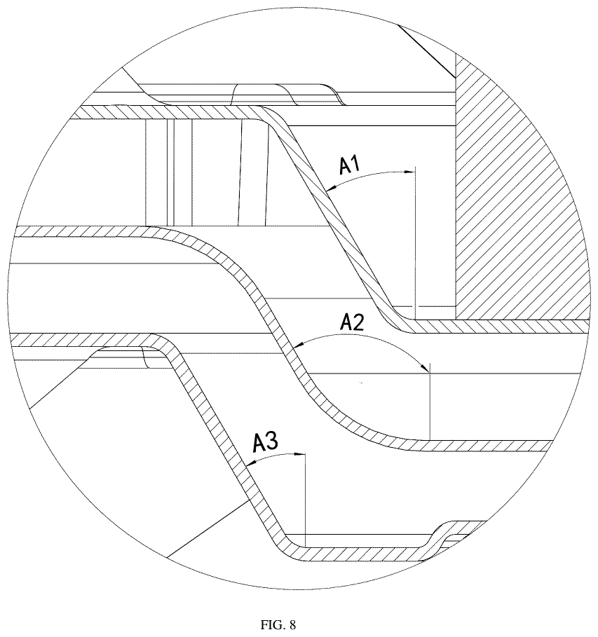

As shown in FIG. 4, FIG. 8 and FIG. 9, each of the first fan blades 412 includes a first positioning plate reinforcement portion 4123, and the first positioning plate reinforcement portion 4123 is arranged on the surface of the first positioning plate 4122 and protrudes in a direction opposite to the forming direction of the first recess 411.

Further, each of the first positioning plates 4122 is approximately a right-angled triangle, and includes a first base portion 41221, a first straight edge 41222, a first top boundary 41223 and a first hypotenuse 41224 which are connected in sequence, where the first positioning plate 4122 is connected to the first recess 411 by means of the first base portion 41221, the first straight edge 41222 extends radially through a center of the circle of the first recess 411, the first hypotenuse 41224 is connected to the first fan plate 4121, the height of the inner casing 2 away from the bottom edge of the first fan plate 4121 is B1, with B1 being 4 mm, and the height from the bottom edge of the first fan plate to the top edge thereof is B2, with B2 being 9.4 mm; and

the exhaust fan 41 includes the ten first fan blades 412 evenly surrounding the edge of the first recess 411, and the included angle formed between the first straight edge of each first positioning plate 4122 and the first hypotenuse of the adjacent first positioning plate 4122 is D2, with D2 being 51 degrees.

Still further, the first positioning plates 4122 are evenly distributed around the first recess 411, and an interstice is formed between the every two adjacent first positioning plates 4122; first fan blade chamfered mouths 4124 are formed by the interstices, and each of the first fan blade chamfered mouths 4124 includes a first fan blade main transition arc 41241 and a first fan blade auxiliary transition arc 41242, where the first fan blade main transition arc 41241 is used for connecting the first hypotenuse 41224 and the first base portion 41221, the first fan blade auxiliary transition arc 41242 is used for connecting the first straight edge 41222 and the first base portion 41221, and the bending directions of the first fan blade main transition arc and the first fan blade auxiliary transition arc are opposite to each other.

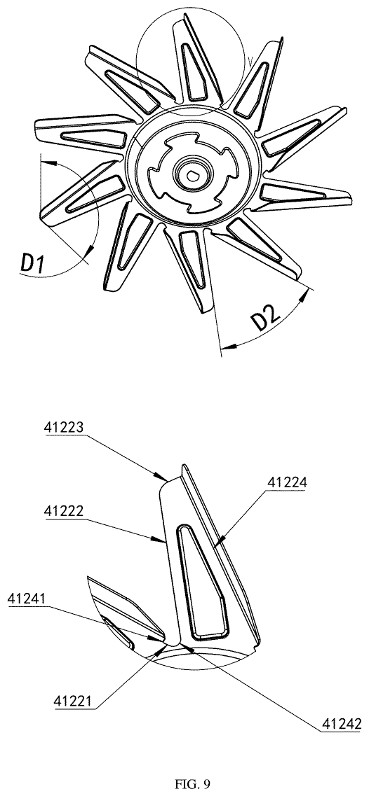

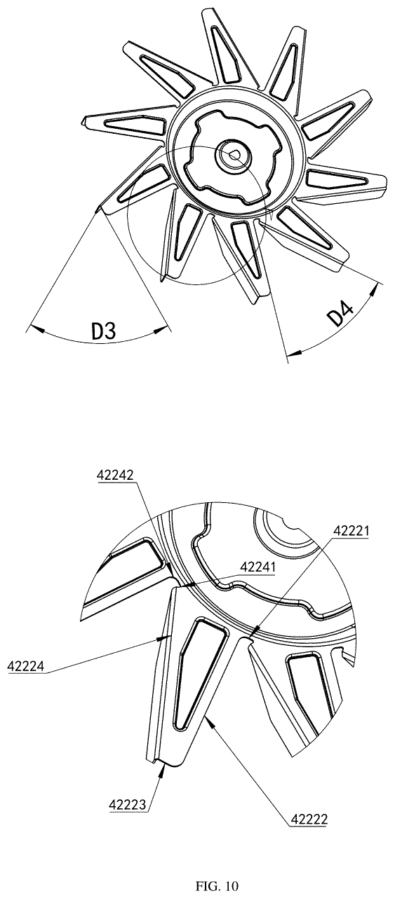

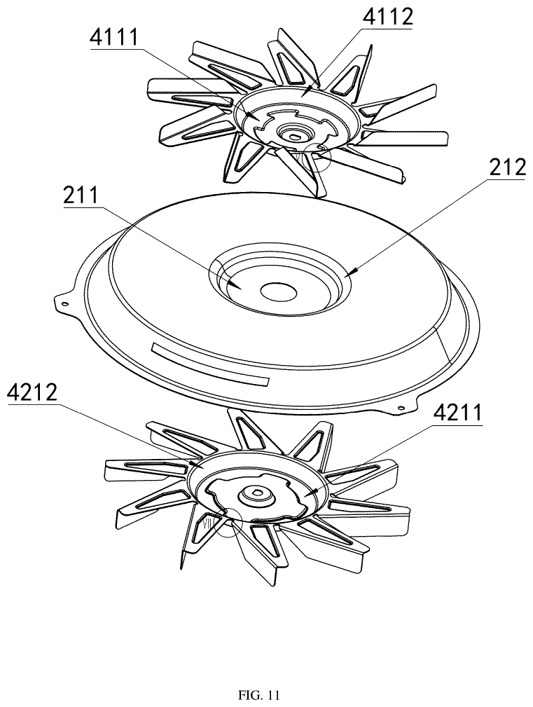

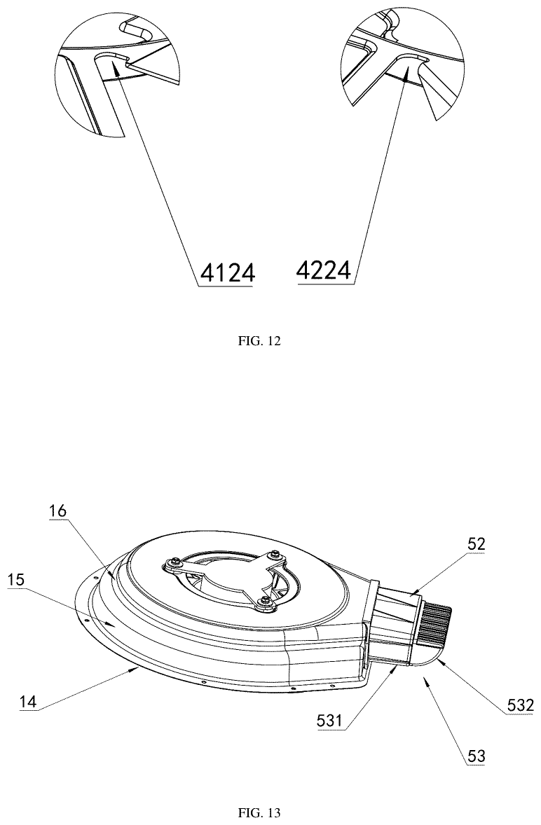

As shown in FIG. 5, FIG. 8 and FIG. 10, each of the second fan blades 422 includes a second positioning plate reinforcement portion 4223, and the second positioning plate reinforcement portion 4223 is arranged on the surface of the second positioning plate 4222 and protrudes towards the recess direction in which the third recess 421 is formed.

Further, each of the second positioning plates 4222 is approximately a right-angled triangle, and includes a second base portion 42221, a second straight edge 42222, a second top boundary 42223 and a second hypotenuse 42224 which are connected in sequence, where the second positioning plate 4222 is connected to the third recess 421 by means of the second base portion 42221, the second straight edge 42222 extends radially through a center of the circle of the third recess 421, the second hypotenuse 42224 is connected to the second fan plate 4221, the height of the inner casing 2 away from the bottom edge of the second fan plate 4221 is B3, with B3 being 3.6 mm, and the height from the bottom edge of the second fan plate to the top edge thereof is B4, with B4 being 13.5 mm; and

the circulation fan 42 includes the ten second fan blades 422 evenly surrounding the edge of the third recess 421, and the included angle formed between the second straight edge 42222 of each second positioning plate 4222 and the second hypotenuse 42224 of the adjacent second positioning plate 4222 is D4, with D4 being 53 degrees.

Still further, the second positioning plates 4222 are evenly distributed around the third recess 421, and an interstice is formed between the every two adjacent second positioning plates 4222; second fan blade chamfered mouths 4224 are formed by the interstices, and each of the second fan blade chamfered mouths 4224 includes a second fan blade main transition arc 42241 and a second fan blade auxiliary transition arc 42242, where the second fan blade main transition arc 42241 is used for connecting the second hypotenuse 42224 and the second base portion 42221, the second fan blade auxiliary transition arc 42242 is used for connecting the second straight edge 42222 and the second base portion 42221, and the bending directions of the second fan blade main transition arc and the second fan blade auxiliary transition arc are opposite to each other.

As shown in FIG. 1, the exhaust component 5 is provided with a plurality of reinforcing ribs. The exhaust component 5 extends towards the outer side of the middle casing 1, the air outlet 51 is provided on the exhaust component 5, and the shape of the air outlet 51 is grid-shaped; the middle casing 1 includes a middle casing bottom plate 14 extending along a plane, and a middle casing side wall 15 extending from the middle casing bottom plate 14 towards one side; the middle casing side wall is provided with the exhaust hole 13; the exhaust component 5 includes an exhaust component top surface 52 and an exhaust component bottom surface 53 which are arranged in sequence along the direction from the middle casing bottom plate 14 to the middle casing side wall 15; the exhaust component bottom surface 53 includes a planar bottom wall 531 and an arc-shaped bottom wall 532 that are connected in sequence; and the air outlet 51 is provided at the side of the exhaust component top surface 52 close to the arc-shaped bottom wall 532.

It is worth mentioning that the middle casing 1 is formed by two-stage upward draft, so that a step-like middle casing stair-shaped surface 16 is formed at the waist of the middle casing; the draft slope of the first stage of the middle casing 1 a is C1, with C1 being 15 degrees; the draft slope of the second stage of the middle casing 1 is C2, with C2 being 15 degrees; and the inner casing 2 has a circular inclined plane, the slope of the inclined plane is C3, with C3 being 30 degrees.

It is more worth mentioning that the first recess 411 includes a first crisscross recess 4113, and the first crisscross recess 4113 is formed by means of draft towards the recess direction of the first recess 411; and the third recess 421 includes a second crisscross recess 4213, and the second crisscross recess 4213 is formed by means of draft in the direction opposite to the recess direction of the third recess 421.

### Embodiment II

An oven lid of a large-capacity air oven provided by the embodiment is as shown in FIG. 14, a first recess 411 is formed on an exhaust fan 41, and at least portion of a DC brushless motor 4 enters the first recess 411; and

a second recess 21 is formed on an inner casing 2, and at least portion of the first recess 411 enters the second recess 21.

A third recess 421 is formed on a circulation fan 42, and at least portion of the second recess 21 enters the third recess 421; and

a plurality of supports 43 are arranged along the outer side surface of the DC brushless motor 4 in an integrated molding manner, and the supports 43 are fixedly connected to the inner casing 2.

In this embodiment, except that the portion of the DC brushless motor 4 is different from that of Embodiment 1, the rest portions are the same as those of Embodiment 1, which will not be repeated here.

### Embodiment III

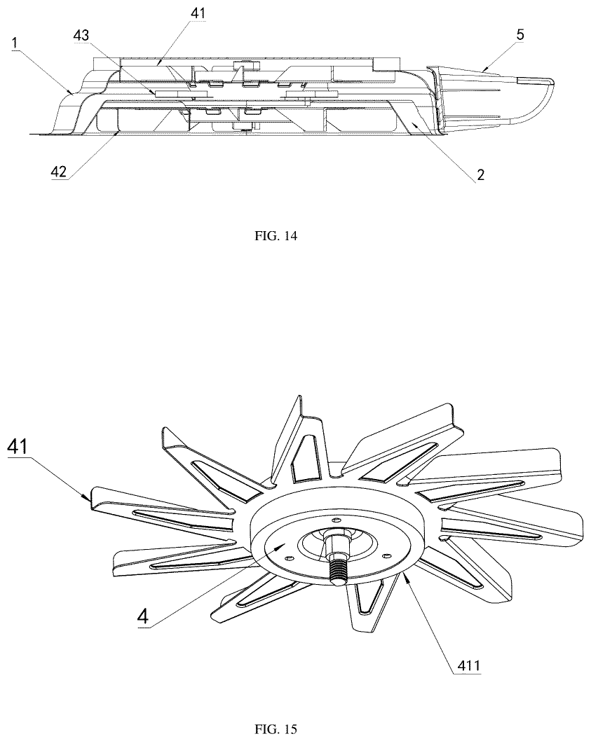

An oven lid of a large-capacity air oven provided by the embodiment is as shown in FIG. 15, an exhaust fan 41 is fixedly connected to a DC brushless motor 4. The exhaust fan 41 includes a first recess 411 and a plurality of first fan blades 412 arranged outside the first recess 411 in a surrounding manner; and the first recess 411 is matched with the outer wall of the DC brushless motor 4.

In this embodiment, except that the portion of the exhaust fan 41 is different from that of Embodiment 1, the rest portions are the same as those of Embodiment 1, which will not be repeated here.

### Embodiment IV

An oven lid of a large-capacity air oven provided by the embodiment includes a casing (not shown in the figure) and a fan assembly; and the air oven includes an outer oven body and an inner oven body, and a cavity is formed between the outer oven body and the inner oven body.

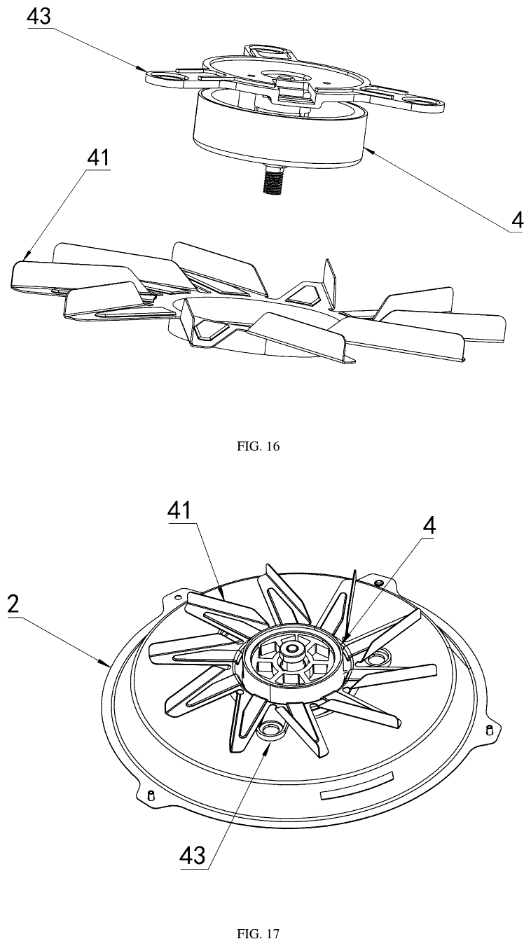

As shown in FIG. 16 and FIG. 17, an inner casing 2 is arranged inside the casing, and the inner casing 2 is fixedly connected to a DC brushless motor 4; an output shaft of the DC brushless motor 4 is connected to an exhaust fan 41 and a circulation fan 42, the exhaust fan 41 is located above the inner casing 2, and the circulation fan 42 is located under the inner casing 2; a first recess 411 is formed on the exhaust fan 41, and at least portion of the DC brushless motor 4 enters the first recess 411; and

a second recess 21 is formed on the inner casing 2, and at least portion of the first recess 411 enters the second recess 21.

A third recess 421 is formed on the circulation fan 42, and at least portion of the second recess 21 enters the third recess 421.

It is worth mentioning that a plurality of supports 43 are arranged along the outer side surface of the DC brushless motor 4 in an integrated molding manner, the supports 43 are fixedly connected to the inner casing 2, and the supports 43 are located under the exhaust fan 41.

The rest portions of this embodiment are the same as those of Embodiment 1, which will not be repeated here.

The foregoing descriptions are merely exemplary implementations of the present invention, the protection scope of the present invention is not limited to the above-mentioned embodiments, and all technical solutions under the idea of the present invention all belong to the protection scope of the present invention. It should be pointed out that for those ordinary persons skilled in the art, some improvements and embellishments without departing from the principle of the present invention shall also fall within the protection scope of the present invention.

1. An oven lid of a large-capacity air oven, comprising a casing, wherein a middle casing (1) is arranged inside the casing, an inner casing (2) is fixedly connected to the bottom of the middle casing (1), a heat dissipation cavity (3) is formed between the middle casing (1) and the inner casing (2), and a central hole (11) communicated with the heat dissipation cavity (3) is provided on the middle casing (1); a DC brushless motor (4) is fixedly connected to the middle casing (1), and an interstice is provided between the DC brushless motor (4) and the central hole (11); an output shaft of the DC brushless motor (4) is fixedly connected to an exhaust fan (41) and a circulation fan (42), the circulation fan (42) is located under the inner casing (2), and the exhaust fan (41) is located inside the heat dissipation cavity (3); and an exhaust component (5) is communicated with one side of the middle casing (1), and an air outlet (51) is provided on the exhaust component (5).

2. The oven lid of the large-capacity air oven according to claim 1, wherein a plurality of supports (43) are arranged along the outer side surface of the DC brushless motor (4) in an integrated molding manner, and the supports (43) are fixedly connected to the middle casing (1).

3. The oven lid of the large-capacity air oven according to claim 2, wherein there are three supports (43), the three supports are evenly distributed along the circumferential direction of the output shaft of the DC brushless motor (4).

4. The oven lid of the large-capacity air oven according to claim 2, wherein a plurality of positioning slots (12) corresponding to the supports (43) are provided on the upper surface of the middle casing (1).

5. The oven lid of the large-capacity air oven according to claim 2, wherein a first recess (411) is formed on the exhaust fan (41), and at least portion of the DC brushless motor (4) enters the first recess (411).

6. The oven lid of the large-capacity air oven according to claim 5, wherein a second recess (21) is formed on the inner casing (2), and at least portion of the first recess (411) enters the second recess (21).

7. The oven lid of the large-capacity air oven according to claim 6, wherein a third recess (421) is formed on the circulation fan (42), and at least portion of the second recess (21) enters the third recess (421).

8. The oven lid of the large-capacity air oven according to claim 1, wherein a through hole (22) is provided on the inner casing (2), an exhaust hole (13) is provided on the middle casing (1), and the exhaust hole (13) corresponds to the through hole (22) and is communicated with the exhaust component (5).

9. The oven lid of the large-capacity air oven according to claim 7, wherein the first recess (411) comprises a first recess bottom surface (4111) and a first circular truncated cone side surface (4112);
the second recess (21) comprises a second recess bottom surface (211) and a second circular truncated cone side surface (212); and
the third recess (421) comprises a third recess bottom surface (4211) and a third circular truncated cone side surface (4212).

10. The oven lid of the large-capacity air oven according to claim 9, wherein the exhaust fan (41) comprises the first recess (411) and a plurality of first fan blades (412) arranged outside the first recess (411) in a surrounding manner; the circulation fan (42) comprises the third recess (421) and a plurality of second fan blades (422) arranged outside the third recess (421) in a surrounding manner;
each of the first fan blades (412) comprises a first fan plate (4121) and a first positioning plate (4122) which are connected to each other, the cross section of the fan blade formed by connecting the first fan plate and the first positioning plate is L-shaped, and the first fan plate (4121) extends in the direction opposite to the forming direction of the first recess (411); and
each of the second fan blades (422) comprises a second fan plate (4221) and a second positioning plate (4222) which are connected to each other, the cross section of the fan blade formed by connecting the second fan plate and the second positioning plate is L-shaped, and the second fan plate (4221) extends towards the recess direction in which the third recess (421) is formed.

11. The oven lid of the large-capacity air oven according to claim 10, wherein each of the first fan blades (412) comprises a first positioning plate reinforcement portion (4123), and the first positioning plate reinforcement portion (4123) is arranged on the surface of the first positioning plate (4122) and protrudes in a direction opposite to the forming direction of the first recess (411); and
each of the second fan blades (422) comprises a second positioning plate reinforcement portion (4223), and the second positioning plate reinforcement portion (4223) is arranged on the surface of the second positioning plate (4222) and protrudes towards the recess direction in which the third recess (421) is formed.

12. The oven lid of the large-capacity air oven according to claim 11, wherein each of the first positioning plates (4122) is approximately a right-angled triangle, and comprises a first base portion (41221), a first straight edge (41222), a first top boundary (41223) and a first hypotenuse (41224) which are connected in sequence, the first positioning plate (4122) is connected to the first recess (411) by means of the first base portion (41221), the first straight edge (41222) extends radially through a center of the circle of the first recess (411), and the first hypotenuse (41224) is connected to the first fan plate (4121); and
each of the second positioning plates (4222) is approximately a right-angled triangle, and comprises a second base portion (42221), a second straight edge (42222), a second top boundary (42223) and a second hypotenuse (42224) which are connected in sequence, the second positioning plate (4222) is connected to the third recess (421) by means of the second base portion (42221), the second straight edge (42222) extends radially through a center of the circle of the third recess (421), and the second hypotenuse (42224) is connected to the second fan plate (4221).

13. The oven lid of the large-capacity air oven according to claim 12, wherein the exhaust fan (41) comprises the ten first fan blades (412) evenly surrounding the edge of the first recess (411); and
the circulation fan (42) comprises the ten second fan blades (422) evenly surrounding the edge of the third recess (421).

14. The oven lid of the large-capacity air oven according to claim 13, wherein the first positioning plates (4122) are evenly distributed around the first recess (411), and an interstice is formed between the every two adjacent first positioning plates (4122); first fan blade chamfered mouths (4124) are formed by the interstices, and each of the first fan blade chamfered mouths (4124) comprises a first fan blade main transition arc (41241) and a first fan blade auxiliary transition arc (41242), the first fan blade main transition arc (41241) is used for connecting the first hypotenuse (41224) and the first base portion (41221), the first fan blade auxiliary transition arc (41242) is used for connecting the first straight edge (41222) and the first base portion (41221), and the bending directions of the first fan blade main transition arc and the first fan blade auxiliary transition arc are opposite to each other;
the second positioning plates (4222) are evenly distributed around the third recess (421), and an interstice is formed between the every two adjacent second positioning plates (4222); second fan blade chamfered mouths (4224) are formed by the interstices, and each of the second fan blade chamfered mouths (4224) comprises a second fan blade main transition arc (42241) and a second fan blade auxiliary transition arc (42242), the second fan blade main transition arc (42241) is used for connecting the second hypotenuse (42224) and the second base portion (42221), the second fan blade auxiliary transition arc (42242) is used for connecting the second straight edge (42222) and the second base portion (42221), and the bending directions of the second fan blade main transition arc and the second fan blade auxiliary transition arc are opposite to each other.

15. The oven lid of the large-capacity air oven according to claim 1, wherein the exhaust component (5) extends towards the outer side of the middle casing (1), the air outlet (51) is provided on the exhaust component (5), and the shape of the air outlet (51) is grid-shaped; the middle casing (2) comprises a middle casing bottom plate (14) extending along a plane, and a middle casing side wall (15) extending from the middle casing bottom plate (14) towards one side; the middle casing side wall (15) is provided with the exhaust hole (13); the exhaust component (5) comprises an exhaust component top surface (52) and an exhaust component bottom surface (53) which are arranged in sequence along the direction from the middle casing bottom plate (14) to the middle casing side wall (15); the exhaust component bottom surface (53) comprises a planar bottom wall (531) and an arc-shaped bottom wall (532) that are connected in sequence; and the air outlet (51) is provided at the side of the exhaust component top surface (52) close to the arc-shaped bottom wall (532).

16. The oven lid of the large-capacity air oven according to claim 15, wherein the middle casing (1) is formed by two-stage upward draft, so that a step-like middle casing stair-shaped surface (16) is formed at the waist of the middle casing; the draft slope of the first stage of the middle casing (1) is C1, with C1 being 15 degrees; the draft slope of the second stage of the middle casing (1) is C2, with C2 being 15 degrees; and
the inner casing (2) has a circular inclined plane, the slope of the inclined plane is C3, with C3 being 30 degrees.

17. The oven lid of the large-capacity air oven according to claim 1, wherein the first recess (411) is formed on the exhaust fan (41), and at least portion of the DC brushless motor (4) enters the first recess (411);
the second recess (21) is formed on the inner casing (2), and at least portion of the first recess (411) enters the second recess (21);
the third recess (421) is formed on the circulation fan (42), and at least portion of the second recess (21) enters the third recess (421); and
the plurality of supports (43) are arranged along the outer side surface of the DC brushless motor (4) in an integrated molding manner, and the supports (43) are fixedly connected to the inner casing (2).

18. The oven lid of the large-capacity air oven according to claim 17, wherein the first recess (411) is matched with the outer wall of the DC brushless motor (4).

19. An oven lid of a large-capacity air oven, comprising an inner casing (2), wherein a DC brushless motor (4) is fixedly connected to the inner casing (2), an output shaft of the DC brushless motor (4) is connected to an exhaust fan (41) and a circulation fan (42), the exhaust fan (41) is located above the inner casing (2), and the circulation fan (42) is located under the inner casing (2); a first recess (411) is formed on the exhaust fan (41), and at least portion of the DC brushless motor (4) enters the first recess (411);
a second recess (21) is formed on the inner casing (2), and at least portion of the first recess (411) enters the second recess (21); and
a third recess (421) is formed on the circulation fan (42), and at least portion of the second recess (21) enters the third recess (421).
